(19) United States
(12) Patent Application Publication
(10) Pub. No.: US 2006/0165304 A1
(43) Pub. Date: Jul. 27, 2006

(54) Multilayer video encoding/decoding method using residual re-estimation and apparatus using the same

(75) Inventors: Bae-keun Lee, Bucheon-si (KR); Sang-chang Cha, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/339,496

(22) Filed: Jan. 26, 2006

Related U.S. Application Data
(60) Provisional application No. 60/647,000, filed on Jan. 27, 2005.

(30) Foreign Application Priority Data
Mar. 26, 2005 (KR) 10-2005-0025238

(51) Int. Cl. G06K 9/46

(52) U.S. Cl. 382/240

(57) ABSTRACT

A multilayer encoding/decoding method using residual re-estimation and an apparatus using the same are disclosed. The multilayer video encoding method includes (a) encoding a first residual image obtained by subtracting a predicted frame from an original frame, (b) decoding the encoded first residual image and generating a first restored frame by adding the decoded residual image to the predicted frame, (c) deblocking the first restored frame, and (d) encoding a second residual image obtained by subtracting the predicted frame from the first deblocked restored frame.

### CROSS-REFERENCE TO RELATED APPLICATIONS

This application claims priority from Korean Patent Application No. 10-2005-0025238 filed on Mar. 26, 2005 in the Korean Intellectual Property Office, and U.S. Provisional Patent Application No. 60/647,000 filed on Jan. 27, 2005 in the United States Patent and Trademark Office, the disclosures of which are incorporated herein by reference in their entirety.

### BACKGROUND OF THE INVENTION

1. Field of the Invention

The present invention relates to a multilayer video encoding/decoding, and more particularly, to a multilayer encoding/decoding method using residual re-estimation and an apparatus using the same, in which the number of bits used for bit stream transmission is reduced by encoding and transmitting a residual image obtained by subtracting a predicted frame or a base layer frame from a deblocked restored frame instead of an original frame.

2. Description of the Prior Art

Currently, with the advancements in information and communication technologies that include the Internet, communications supporting multimedia contents are fast increasing along with text messaging and voice communication. The existing text-based communication systems are insufficient to meet consumers' diverse needs, and thus multimedia services that can deliver various forms of information such as texts, images, music, and others, are increasing. Since multimedia data is typically massive in its content, a large storage medium and a wide bandwidth are required for storing and transmitting multimedia data. Accordingly, compression coding techniques are generally applied to transmit multimedia data including texts, images and audio data.

Generally, data compression is applied to remove data redundancy. Here, data can be compressed by removing spatial redundancy such as a repetition of the same color or object in images, temporal redundancy such as little or no change in adjacent frames of moving image frames or a continuous repetition of sounds in audio, and a visual/perceptual redundancy, which considers human visual and perceptive insensitivity to high frequencies. In conventional video encoding methods, the temporal redundancy is removed by a temporal prediction based on motion compensation, while the spatial redundancy is removed by a spatial transform.

After removing the redundancies, multimedia data is transmitted over a transmitting medium or a communication network, which may differ in terms of performance, as existing transmission mediums have varying transmission speeds. For example, an ultrahigh-speed communication network can transmit several tens of megabits of data per second, while a mobile communication network has a transmission speed of 384 kilobits per second. In order to support the transmission medium in such transmission environments and to transmit a multimedia data stream with a transmission rate suitable for a transmission environment, a scalable video encoding method is implemented.

Such a scalable video encoding method makes it possible to truncate a portion of a compressed bit stream and to adjust the resolution, frame rate and signal-to-noise ratio (SNR) of a video corresponding to the truncated portion of the bit stream. With respect to the scalable video coding, MPEG-4 (Moving Picture Experts Group Layer-4 Video) Part 10 has already made progress on a standard for this feature.

Particularly, much research for implementing scalability in a video encoding method based on a multilayer has been carried out. As an example of such a multilayered video encoding, a multilayer structure having a base layer, a first enhancement layer and a second enhancement layer has been proposed, in which the respective layers have different resolutions QCIF, CIF and 2CIF, and different frame rates or different SNRs.

Among the multilayered scalability techniques, SNR scalability technique encodes an input video image into two layers having the same frame rate and resolution but different accuracies of quantization. In particular, the fine grain SNR (FGS) scalability technique encodes the input video image into a base layer and an enhancement layer, and then encodes a residual image of the enhancement layer. FGS scalability technique may or may not transmit the encoded signals to prevent the signals from being decoded by a decoder according to the network transmission efficiency or the state of the decoder side. Accordingly, data can be properly transmitted with its amount adjusted to the transmission bit rate of a network.

However, since the transmission of the enhancement layer bit stream is still limited by the transmission bit rate of a network even for SNR scalable video encoding, a method capable of transmitting more enhanced-layer data even at the conventional transmission bit rates is desired.

### SUMMARY OF THE INVENTION

Accordingly, the present invention has been made to address the above-mentioned problems in the prior art, and an aspect of the present invention is to provide a multilayer video encoding/decoding method using residual re-estimation and an apparatus using the same, in which the number of bits used for encoding a residual image can be efficiently reduced by using a frame, instead of the original frame, from which information to be removed by deblocking has already been removed.

Another aspect of the present invention is to provide a multilayer video encoding/decoding method that can provide a high-quality video image from which block artifacts have been removed by performing a deblocking process for respective layers during the multilayer video encoding/decoding.

Additional advantages, and features of the invention will be set forth in part in the description which follows and in part will become apparent to those having ordinary skill in the art upon examination of the following or may be learned from practice of the invention.

In an aspect of the invention, there is provided a multilayer video encoding method, according to an embodiment of the present invention, which includes (a) encoding a first residual image obtained by subtracting a predicted frame from an original frame, (b) decoding the encoded first residual image and generating a first restored frame by adding the decoded residual image to the predicted frame, (c) deblocking the first restored frame and (d) encoding a second residual image obtained by subtracting the predicted frame from the first deblocked restored frame.

In another aspect of the present invention, there is provided a multilayer video decoding method, which includes (a) extracting data corresponding to a residual image from a bit stream, (b) restoring the residual image by decoding the data, and (c) restoring a video frame by adding the residual image to a restored predicted frame, wherein the bit stream is a bit stream of an encoded second residual image obtained by (d) encoding a first residual image obtained by subtracting the predicted frame from an original frame, (e) decoding the encoded first residual image and generating a first restored frame by adding the decoded first residual image to the predicted frame, (f) deblocking the first restored frame, and (g) encoding a second residual image obtained by subtracting the predicted frame from the first deblocked restored frame.

In still another aspect of the present invention, there is provided a multilayer video encoder, which includes a temporal transform unit for removing a temporal redundancy of a first residual image obtained by subtracting a predicted frame from an original frame, a spatial transform unit for removing a spatial redundancy of the first residual image from which the temporal redundancy has been removed, a quantization unit for quantizing transform coefficients provided by the spatial transform unit, an entropy encoding unit for encoding the quantized transform coefficients, a dequantization unit for dequantizing the quantized transform coefficients, an inverse spatial transform unit for generating a first restored residual image by performing an inverse spatial transform on the dequantized transform coefficients, and a deblocking unit for deblocking a first restored frame by adding the first restored residual image to the predicted frame, wherein the spatial transform unit removes the spatial redundancy of a second residual image obtained by subtracting the predicted frame from the first deblocked restored frame.

In still another aspect of the present invention, there is provided a multilayer video decoder, which includes an entropy decoding unit for extracting data corresponding to a residual image from a bit stream, a dequantization unit for dequantizing the extracted data, an inverse spatial transform unit for restoring the residual image by performing an inverse spatial transform on the dequantized data, and an adder for restoring a video frame by adding the restored residual image to a pre-restored predicted frame, wherein the bit stream is a bit stream of an encoded second residual image obtained by (a) encoding a first residual image obtained by subtracting the predicted frame from an original frame, (b) decoding the encoded first residual image and generating a first restored frame by adding the decoded first residual image to the predicted frame, (c) deblocking the first restored frame, and (d) encoding a second residual image obtained by subtracting the predicted frame from the first deblocked restored frame.

### BRIEF DESCRIPTION OF THE DRAWINGS

The above and other features and advantages of the present invention will be more apparent from the following detailed description taken in conjunction with the accompanying drawings, in which:

FIG. 1 is a view illustrating an FGS encoding process in an SVM3.0 process;

FIG. 2 is a view illustrating an FGS decoding process in an SVM3.0 process;

FIG. 3 is a view illustrating a residual re-estimation process in an FGS encoding process according to an embodiment of the present invention;

FIG. 4 is a block diagram illustrating the construction of an encoder according to an embodiment of the present invention;

FIG. 5 is a block diagram illustrating the construction of a decoder according to an embodiment of the present invention;

FIG. 6 is a view illustrating a residual re-estimation process in a general multilayer structure according to another embodiment of the present invention;

FIG. 7 is a block diagram illustrating the construction of an encoder according to another embodiment of the present invention; and

FIG. 8 is a block diagram illustrating the construction of a decoder according to another embodiment of the present invention.

### DETAILED DESCRIPTION OF EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in various forms without departing from the spirit of the invention. The matters defined in the description, such as detailed construction and elements, are but specific details provided to assist those having ordinary skill in the art in a comprehensive understanding of the invention. The same reference numerals are used to denote the same elements throughout the description and drawings.

The fine grain SNR (FGS) of a scalable video model (SVM) 3.0 is implemented using a gradual refinement representation. The SNR scalability may be achieved by truncating NAL units obtained as the result of FGS encoding at any point, while the FGS scalability is implemented by using a base layer and an FGS enhancement layer. The base layer is used to generate a base layer frame which represents the minimum video quality and which can be transmitted at the lowest transmission bit rate. In addition, the FGS enhancement layer is used to generate NAL units which can be properly truncated and transmitted above the lowest transmission bit rate or which can be properly truncated and decoded by a decoder. The FGS enhancement layer transforms, quantizes and transmits a residual signal obtained by subtracting a restored frame, which is obtained in the base layer or a lower enhancement layer, from the original frame. In the FGS enhancement layer, the SNR scalability is implemented by generating a more exquisite residual by gradually reducing quantization parameter values in upper layers.

The quantization parameters QPᵢ (the base layer is indicated by i=0) for macroblocks of an i-th enhancement layer, which are used in the process of restoring the residual value, are determined as follows.

1) If a macroblock includes no transform coefficient and a transform coefficient level that is not 0 is transmitted for the macroblock from a base layer representation or a certain previous enhancement layer representation, the quantization parameter is calculated as described in AVC[1] using a grammar element mb_qp_delta.

2) Otherwise (that is, if the macroblock includes at least one transform coefficient and the transform level that is not 0 is transmitted for the macroblock from the base layer representation or the previous enhancement layer representation), the quantization parameter is calculated by Equation (1).
QPᵢ=min(0, QPᵢ₋₁−6) (1)

Restoration of a transform coefficient cₖ in a scanning position K on the decoder side is obtained from

$${c}_{k} = {\sum }_{i = 0} InverseScaling ( {l}_{i , k} , {QP}_{i} , k )$$

where, l_{i,k} represents a transform coefficient level encoded in the i-th enhancement layer for the transform coefficient cₖ, and QPᵢ denotes the quantization parameter of the corresponding macroblock. In addition, the function InverseScaling(.) represents a coefficient restoration process.

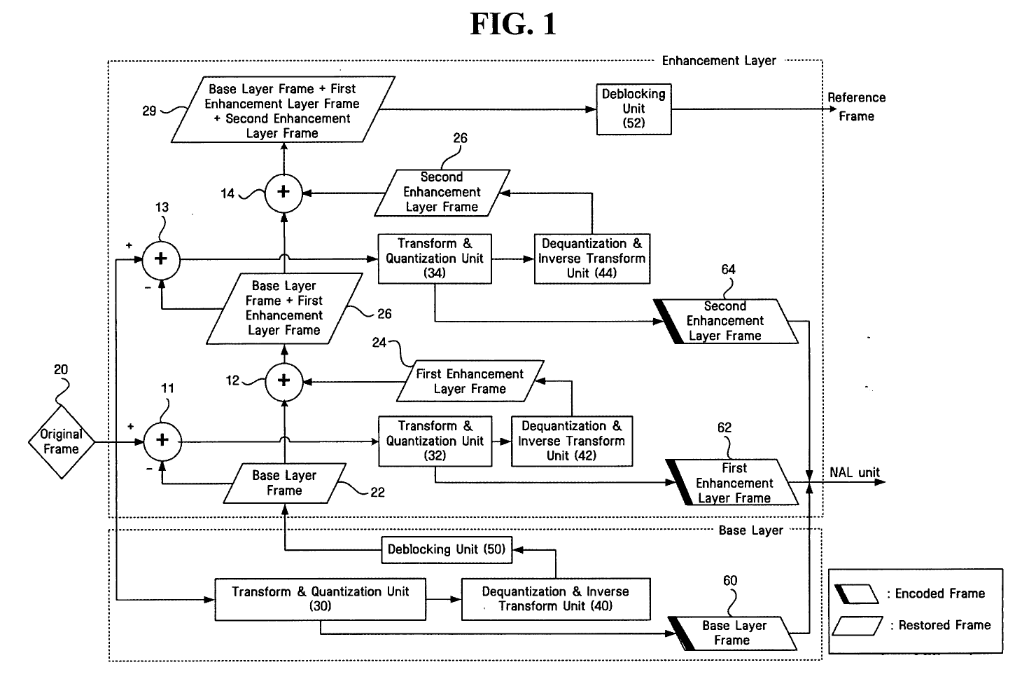

FIG. 1 is a view illustrating an FGS encoding process in an SVM3.0 process.

First, a base layer frame is obtained using an original frame 20. The original frame 20 may be a frame extracted from a group of pictures (GOP), or a frame in which the motion compensated temporal filtering (MCTF) of the GOPs has been performed. A transform & quantization unit 30 performs transform and quantization to generate a base layer frame 60 from the original frame 20. A dequantization & inverse transform unit 40 performs dequantization and inverse transform in order to provide the base layer frame 60, which has passed through the transform and quantization process, to the enhancement layer. This process is to make the base layer frame consistent with a frame decoded by the decoder since the decoder can only recognize the restored frame. In addition, a frame of a general FGS base layer is deblocked by a deblocking unit 50 and provided to the enhancement layer.

In the case of video decoding, a block artifact may appear because an input frame is encoded and transmitted with block-based information. The deblocking is to cancel the block artifact. In general, the restored frame is deblocked in the case where the restored frame is used as a reference frame for prediction. Through this deblocking process, specified bits are removed by filtering.

In the enhancement layer which is a layer that generates an exquisite residual signal to be added to the base layer frame, the residual signal, i.e., the difference between the original frame 20 and a restored base layer frame 22 or a restored lower enhancement layer frame 26, is obtained. The residual signal is then added to the original frame by the decoder to restore the original video data.

A subtracter 11 of the first enhancement layer subtracts the frame 22 restored from the base layer from the original frame. The residual signal obtained from the subtracter 11 is outputted as a first enhancement layer frame 62 through the transform and quantization unit 32. The first enhancement layer frame 62 is also restored by a dequantization & inverse transform unit 42 to be provided to the second enhancement layer. An adder 12 generates a new frame 26 by adding the first enhancement layer frame 24 to the restored base layer frame 22, and provides the frame 26 to the second enhancement layer.

A subtracter 13 of the second enhancement layer subtracts the frame 26 provided from the first enhancement layer from the original frame 20. This subtracted value is outputted as the second enhancement layer frame 64 through a transform & quantization unit 34. The second enhancement layer frame 64 is then restored by a dequantization & inverse transform unit 44, and then added to the frame 26 to be provided as a new frame 29. In the case where the second enhancement layer is the uppermost layer, the frame 29 is deblocked through a deblocking unit 52 before it is used as a reference frame for other frames.

The base layer frame 60, the first enhancement layer frame 62 and the second enhancement frame 64 may be transmitted in the form of a network abstraction layer (NAL) unit. The decoder can restore data even if the received NAL unit is partially truncated.

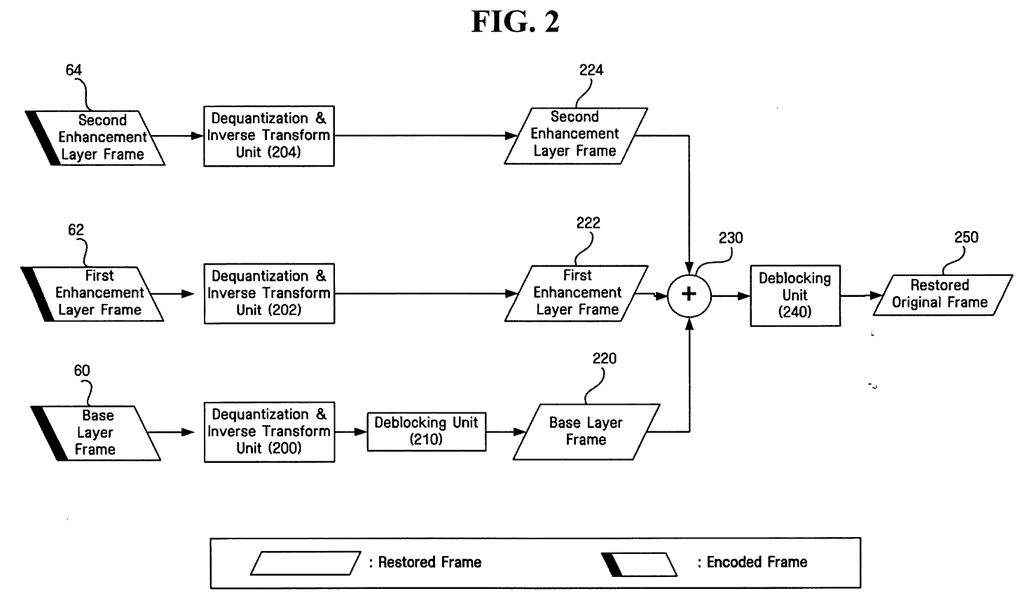

FIG. 2 is a view illustrating an FGS decoding process in an SVM3.0 process.

An FGS decoder receives the base layer frame 60, the first enhancement layer frame 62 and the second enhancement layer frame 64 obtained by an FGS encoder. Since these frames are encoded data, they are decoded through dequantization & inverse transform units 200, 202 and 204. The frames restored through the dequantization & inverse transform unit 200 of the base layer are then deblocked by a deblocking unit 210 to be restored to the base layer frame.

Restored frames 220, 222, 224 are added together by an adder 230. The added frames are again deblocked by a deblocking unit 240, so that boundaries among the blocks are erased. This process corresponds to the deblocking of the uppermost enhancement layer in the FGS encoder.

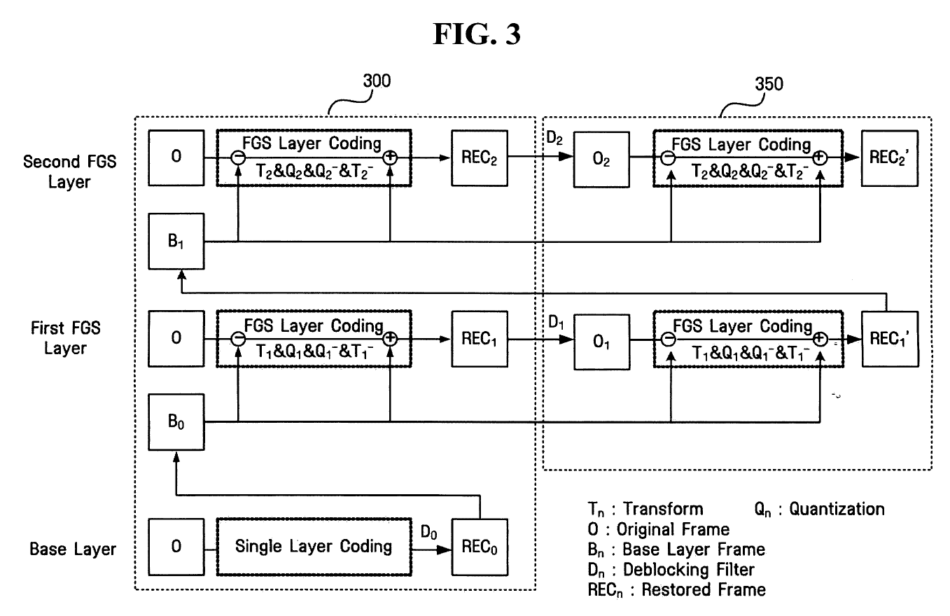

FIG. 3 is a view illustrating a residual re-estimation process in an FGS encoding process according to an embodiment of the present invention.

In the residual re-estimation process according to an embodiment of the present invention, the restored frame, which is used as the reference frame in the enhancement layer of the FGS encoder, is deblocked to be used as a new original frame. Accordingly, a new residual, that is obtained by subtracting the reference frame obtained and restored in the lower layer from the new deblocked original frame, is encoded and transmitted to the decoder, so that the block artifact is reduced by the number of bits of the unnecessary data to be removed by deblocking.

A left part 300 in FIG. 3 represents the FGS encoding process in a conventional SVM3.0 process, and a right part 350 represents a process added for the residual re-estimation according to an embodiment of the present invention. The FGS encoding of SVM3.0 generates the base layer frame by transforming and quantizing an original frame 0 in the base layer as described above with reference to FIG. 1. The bit stream of the obtained base layer frame is transmitted to the decoder side and is simultaneously restored through the dequantization and inverse transform process to be used as the reference frame of the enhancement layer. In this case, in order to remove the block artifact, the restored base layer frame passes through a deblocking process D₀ before it is used as a reference frame B₀ of the upper enhancement layer. In a first FGS layer according to an embodiment of the present invention, the residual (hereinafter referred to as “R1”) obtained by subtracting the reference frame B₀ from the original frame O is transformed and quantized in the same manner as the conventional encoding process, and a restored frame REC₁ is obtained by performing dequantization and inverse transform of the quantized residual. Then, the restored frame REC₁ is obtained. Additionally, a frame O₁ is obtained by performing deblocking D₁ of the restored frame REC₁, and the residual (hereinafter referred to as “R2”) is re-estimated with reference to the new original frame O₁ instead of the previous original frame. Here, the new residual R2 is expressed by Equation (2),

$$\begin{matrix}R 2 = {D}_{1} ( {B}_{0} + R {1}^{′} ) - {B}_{0} \\ = {O}_{1} - {B}_{0}\end{matrix} \qquad ( 2 )$$

where, R1′ denotes a restored residual after RI is transformed and quantized.

The bit stream of the first FGS layer is obtained by transforming and quantizing the residual obtained by subtracting the reference frame B₀ from the frame O₁ and then transmitted to the decoder. Meanwhile, a frame REC1′ restored by adding a value that is obtained by performing dequantization and inverse transform of the re-estimated residual to the reference frame B₀ is used as a reference frame B₁ of the upper enhancement layer (i.e., a second FGS layer). The restored frame REC₁′ is expressed by Equation (3).
REC₁′=T−1(Q−1(Q(T(D₁(B₀+R₁′)−B₀)))) (3)

The transform and quantization process in the residual re-estimation process is the same as the transform and quantization process used for the FGS encoding of the same layer.

Even in the second FGS layer, a new residual can be encoded and transmitted through the same process as in the first FGS layer as described above.

In the embodiment of the present invention, since a deblocking D₀ is performed on the base layer, a deblocking Dₙ applied to the enhancement layer can be performed with a weaker strength than the deblocking D₀.

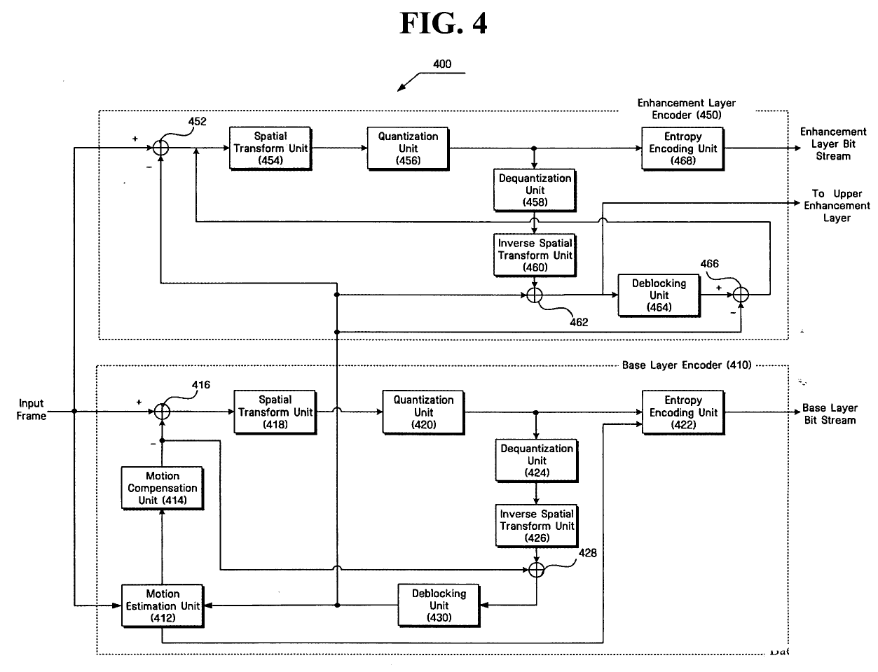

FIG. 4 is a block diagram illustrating the construction of an encoder 400 according to an embodiment of the present invention.

The encoder performs the residual re-estimation in the FGS encoding as shown in FIG. 3, and may include a base layer encoder 410 and an enhancement layer encoder 450. In the embodiments of the present invention, it is exemplified that a base layer and an enhancement layer are used. However, it will be apparent to those skilled in the art that the present invention can be also applied to cases where more layers are used.

The base layer encoder 410 may include a motion estimation unit 412, a motion compensation unit 414, a spatial transform unit 418, a quantization unit 420, an entropy encoding unit 422, a dequantization unit 424, an inverse spatial transform unit 426 and a deblocking unit 430.

The motion estimation unit 412 performs motion estimation of the present frame on the basis of the reference frame among input video frames, and obtains motion vectors. In the embodiment of the present invention, the motion vectors for prediction are obtained by receiving the restored frame that has been deblocked from the deblocking unit 430. A widely used block matching algorithm can be used for such motion estimation. The block matching algorithm estimates a displacement that corresponds to the minimum error as a motion vector as it moves a given motion block in pixel units of a specified search area in the reference frame. For the motion estimation, a motion block having a fixed size or a motion block having a variable size according to a hierarchical variable size block matching (HVSBM) may be used. The motion estimation unit 412 provides motion data such as motion vectors obtained from the motion estimation, the size of the motion block, the reference frame number, and others, to the entropy encoding unit 422.

The motion compensation unit 414 generates a temporally predicted frame of the present frame by performing motion compensation for a forward or backward reference frame using the motion vectors calculated by the motion estimation unit 412.

The subtracter 416 removes the temporal redundancy existing between the frames by subtracting the temporally predicted frame provided from the motion compensation unit 414 from the present frame.

The spatial transform unit 418 removes a spatial redundancy from the frame, from which the temporal redundancy has been removed by the subtracter 416, using a spatial transform method that supports spatial scalability. A discrete cosine transform (DCT), a wavelet transform, and others may be used as the spatial transform method. Coefficients obtained from the spatial transform are transform coefficients. If the DCT method is used as the spatial transform method, the coefficients are DCT coefficients, while if the wavelet transform is used, the coefficients are wavelet coefficients.

The quantization unit 420 quantizes the transform coefficients obtained by the spatial transform unit 418. Quantization is a way of indicating the transform coefficients, which are expressed as certain real values, as discrete values by dividing the transform coefficients into specified sections and then matching the discrete values with specified indexes.

The entropy encoding unit 422 performs a lossless coding of the transform coefficients quantized by the quantization unit 420 and motion data provided from the motion estimation unit 412, and generates an output bit stream. An arithmetic coding, a variable length coding, and others may be used as the lossless coding method.

In the case where the video encoder 400 supports a closed-loop video encoder for reducing drifting errors generated between the encoder side and the decoder side, it may further include the dequantization unit 424, the inverse spatial transform unit 426, and others.

The dequantization unit 424 dequantizes the coefficients quantized by the quantization unit 420. This dequantization process corresponds to the inverse process of the quantization.

The inverse spatial transform unit 426 performs the inverse spatial transform of the result of the dequantization, and provides the result of the inverse spatial transform to an adder 428.

The adder 428 restores the video frame by adding the restored residual frame provided from the inverse spatial transform unit 426 to the predicted frame provided from the motion compensation unit 414 and stored in a frame buffer (not illustrated), and provides the restored video frame to the deblocking unit 430.

The deblocking unit 430 receives the video frame restored by the adder 428 and performs the deblocking to remove the artifact caused by the boundaries of blocks in the frame. The deblocked restored video frame is provided to an enhancement layer encoder 450 as the reference frame.

Meanwhile, the enhancement layer encoder 450 may include a spatial transform unit 454, a quantization unit 456, an entropy encoding unit 468, a dequantization unit 458, an inverse spatial transform unit 460 and a deblocking unit 464.

A subtracter 452 generates a residual frame by subtracting the reference frame provided by the base layer from the current frame. The residual frame is encoded through the spatial transform unit 454 and the quantization unit 456, and is restored through the dequantization unit 458 and the inverse spatial transform unit 460.

An adder 462 generates a restored frame by adding the restored residual frame provided from the inverse spatial transform unit 460 to the reference frame provided by the base layer. The restored frame is deblocked by the deblocking unit 464. A subtracter 466 generates and provides a new residual frame to the spatial transform unit 454 in consideration of the deblocked frame as the new current frame. The new residual frame is processed through the spatial transform unit 454, the quantization unit 456 and the entropy encoding unit 468 to be outputted as an enhanced layer bit stream, and then is restored through the dequantization unit 458 and the inverse spatial transform unit 460. The adder 462 adds the restored new residual image to the reference frame provided by the base layer, and provides the restored new frame to the upper enhancement layer as the reference frame.

Since the operations of the spatial transform unit 454, the quantization unit 456, the entropy encoding unit 468, the dequantization unit 458 and the inverse spatial transform unit 460 are the same as those existing in the base layer, the explanation thereof will be omitted.

Although it is exemplified that a plurality of constituent elements have the same names with different reference numbers in FIG. 4, it will be apparent to those skilled in the art that one constituent element can operate in both the base layer and the enhancement layer.

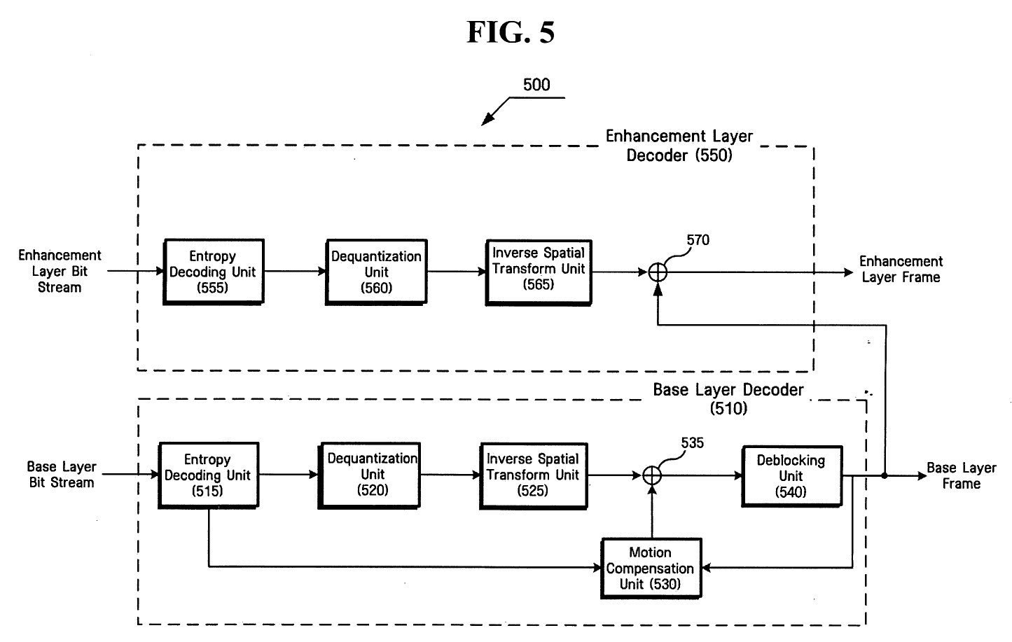

FIG. 5 is a block diagram illustrating the construction of a decoder according to an embodiment of the present invention.

A video decoder 500 may include a base layer decoder 510 and an enhancement layer decoder 550.

The enhancement layer decoder 550 may include an entropy decoding unit 555, a dequantization 560 and an inverse spatial transform unit 565.

The entropy decoding unit 555 extracts texture data by performing the lossless decoding that is reverse to the entropy encoding. The texture information is provided to the dequantization unit 560.

The dequantization unit 560 dequantizes the texture information transmitted from the entropy encoding unit 555. The dequantization process is to search for quantized coefficients that match values transferred from the encoder 600 with specified indexes.

The inverse spatial transform unit 565 inversely performs the spatial transform and restores the coefficients obtained from the dequantization of the residual image in a spatial domain. For example, if the coefficients are spatially transformed by a wavelet transform method in the video encoder side, the inverse spatial transform unit 565 will perform the inverse wavelet transform, while if the coefficients are transformed by a DCT transform method in the video encoder side, the inverse spatial transform unit will perform the inverse DCT transform.

An adder 570 restores the video frame by adding the residual image restored by the inverse spatial transform unit to the reference frame provided from the deblocking unit 540 of the base layer decoder 510.

The base layer decoder 510 may include an entropy decoding unit 515, a dequantization unit 520, an inverse spatial transform unit 525, a motion compensation unit 530 and a deblocking unit 540.

The entropy decoding unit 515 performs the lossless decoding that is inverse to the entropy encoding, and extracts texture data and motion data. The texture information is provided to the dequantization unit 520.

The motion compensation unit 530 performs motion compensation of the restored video frame using the motion data provided from the entropy decoding unit 515 and generates a motion-compensated frame. This motion compensation process is applied only to the case where the present frame has been encoded by a temporal predication process in the encoder side.

An adder 535 restores the video frame by adding the residual image to the motion compensated frame provided from the motion compensation unit 530 if the residual image restored by the inverse spatial transform unit 525 is obtained by the temporal prediction.

The deblocking unit 540, which corresponds to the deblocking unit 430 of the base layer encoder as illustrated in FIG. 4, generates the base layer frame by deblocking the video frame restored by the adder 535, and provides the base layer frame to the adder 570 of the enhancement layer decoder 550 as the reference frame.

Since the operations of the dequantization unit 520 and the inverse spatial transform unit 525 are the same as those in the enhancement layer, the explanation thereof will be omitted.

Although it is exemplified that a plurality of constituent elements have the same names with different reference numbers in FIG. 5, it will be apparent to those skilled in the art that one constituent element having a specified name can operate in both the base layer and the enhancement layer.

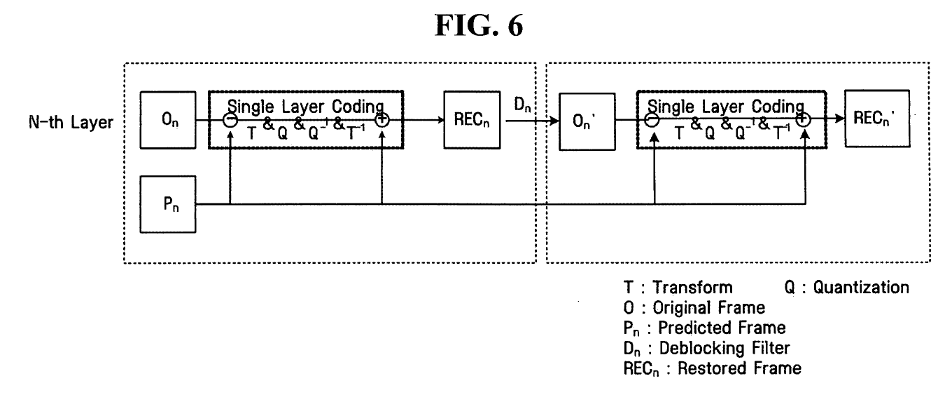

Although the residual re-estimation process in the FGS encoding process based on SVM 3.0 has been described, the residual re-estimation process according to the embodiments of the present invention can be extended to a general multilayer video coding. That is, by re-estimating the residual in consideration of the deblocked restored frame as the new original frame, instead of the residual obtained by subtracting the predicted frame from the original frame, unnecessary data to be removed by the deblocking is removed in advance, and the number of bits being transmitted is reduced. FIG. 6 is a view illustrating a residual re-estimation process in a general multilayer structure according to another embodiment of the present invention.

In an N-th layer of a general multilayer structure, the residual image obtained by subtracting a predicted frame Pₙ from an original frame Oₙ is transformed and quantized to be transmitted to the decoder side, and the restored frame RECₙ is obtained by adding the predicted frame to a value obtained by dequantizing and inverse-transforming the residual. Then, by performing the deblocking Dₙ of the RECₙ, the reference frame to be provided for prediction is obtained.

However, in the N-th layer according to the embodiment of the present invention, a frame Oₙ′ obtained by applying the deblocking Dₙ to the restored frame REC that is obtained after the above-described residual creation and frame restoration processes is considered as the new original frame, and a new residual image is obtained by subtracting an inter-predicted frame (or macroblock) P from the frame Oₙ′. Then, the new residual image is transformed and quantized to be transmitted to the decoder side. Also, the frame RECₙ′ restored by performing the transform and quantization of the residual image and adding the quantized residual image to the predicted frame Pₙ, is used as the reference frame for generating a predicted frame of another frame.

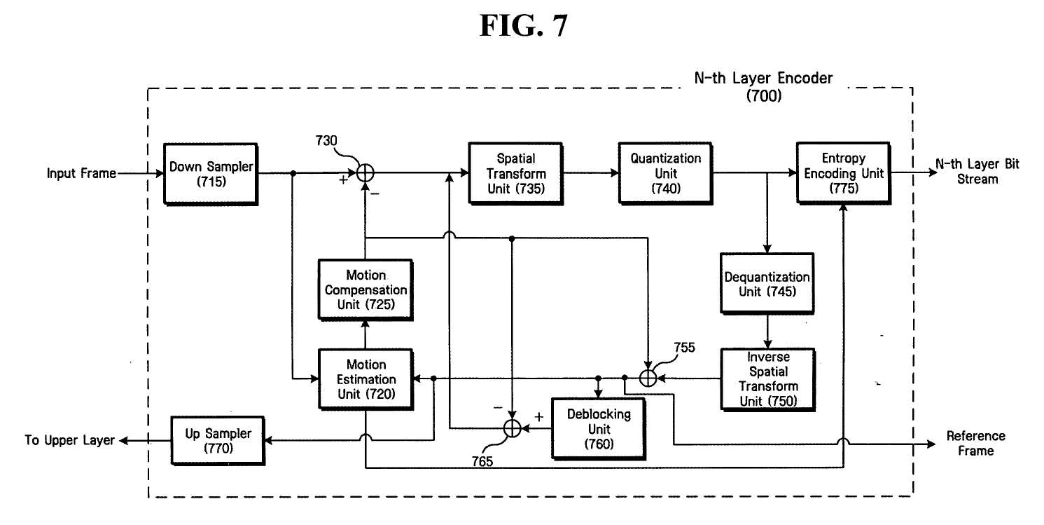

FIG. 7 is a block diagram illustrating the construction of an encoder according to another embodiment of the present invention.

An N-th layer encoder 700 according to the embodiment of the present invention may include a down sampler 715, a motion estimation unit 720, a motion compensation unit 725, a spatial transform unit 735, a quantization unit 740, a dequantization unit 745, an inverse spatial transform unit 750, a deblocking unit 760, an up sampler 770 and an entropy encoding unit 775.

The down sampler 715 performs down-sampling of the original input frame by resolution of the N-th layer. This down-sampling is performed on the assumption that the resolution of an upper enhancement layer and the resolution of the N-th layer differ, and thus the down-sampling may be omitted if the resolutions of both layers are equal to each other.

The subtracter 730 removes the temporal redundancy of the video by subtracting a temporally predicted frame obtained by the motion compensation unit 725 from the present frame.

The spatial transform unit 735 removes the spatial redundancy of the frame from which the temporal redundancy has been removed by the subtracter 730 using the spatial transform method that supports the spatial scalability. Additionally, the spatial transform unit 735 removes the spatial redundancy of the new residual image obtained by subtracting the temporally predicted frame obtained by the motion compensation unit 725 from the frame restored by an adder 755 and the deblocking unit 760.

The adder 755 restores the N-th layer input frame by adding the residual image (i.e., a value obtained by subtracting the temporally predicted frame from the input frame) restored by the inverse spatial transform unit 750 to the temporally predicted frame, and provides the restored frame to the deblocking unit 760.

The deblocking unit 760 generates a new N-th layer input frame by deblocking the N-th layer input frame restored by the adder 755, and provides the obtained frame to the subtracter 765.

The up sampler 770 performs up-sampling of the signal outputted from the adder 755, i.e., the new N-th layer video frame restored by adding the new residual image and the temporally predicted frame if needed, and provides the up-sampled frame to the upper enhancement layer encoder as the reference frame. If the resolutions of the upper enhancement layer and the N-th layer are equal to each other, the up sampler 770 may not be used.

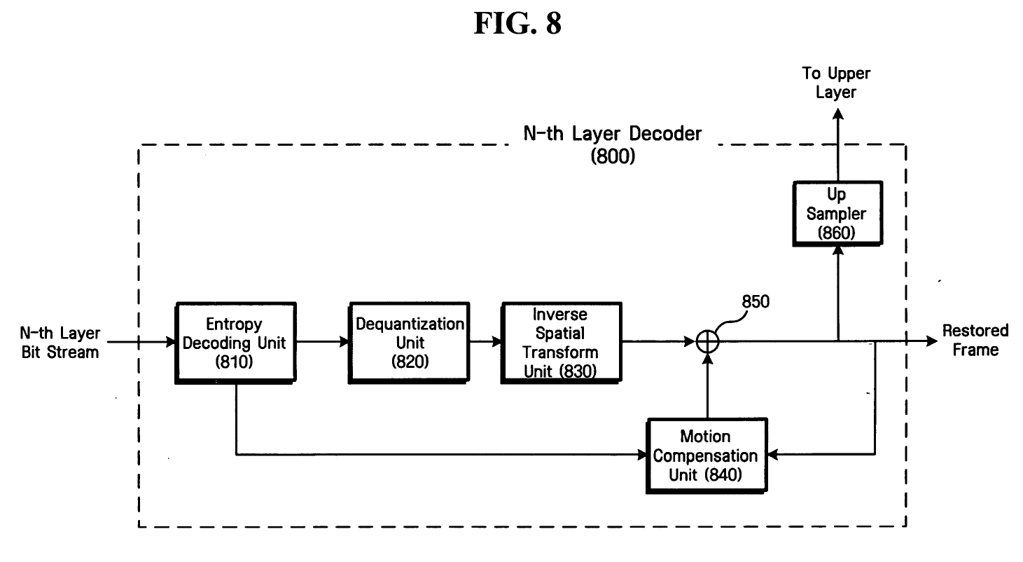

FIG. 8 is a block diagram illustrating the construction of a decoder according to another embodiment of the present invention.

An N-th layer decoder 800 according to the embodiment of the present invention may include an entropy decoding unit 810, a dequantization unit 820, an inverse spatial transform unit 830, a motion compensation unit 840 and an up sampler 860.

The up sampler 860 performs up-sampling of the N-th layer image restored in the N-th layer decoder 800 by resolution of the upper enhancement layer and provides the up-sampled image to the upper enhancement layer. If the resolutions of the upper enhancement layer and the N-th layer are equal to each other, the up-sampling process may be omitted.

Since the operations of the entropy decoding unit 810, the dequantization unit 820, the inverse spatial transform unit 830 and the motion compensation unit 840 are the same as those in the FGS decoder as illustrated in FIG. 5, the explanation thereof will be omitted.

The respective constituent elements as illustrated in FIGS. 4, 5, 7 and 8 may be software or hardware such as a field-programmable gate array (FPGA) and an application-specific integrated circuit (ASIC). However, the constituent elements are not limited to software or hardware. The constituent elements may be constructed so as to be in a storage medium that can be addressed or to execute one or more processors. The functions provided in the constituent elements may be implemented by subdivided constituent elements, and the constituent elements and functions provided in the constituent elements may be combined together to perform a specified function. In addition, the constituent elements may be implemented so as to execute one or more computers in a system.

As described above, the multilayer video encoding/decoding method using residual re-estimation and an apparatus using the same according to the present invention has at least one of the following effects.

First, the number of bits used for encoding the residual signal can be reduced by using a frame from which redundant information has been removed by deblocking as the original frame.

Second, a high-quality video frame from which block artifacts have been removed can be provided by performing a deblocking process for respective layers in the multilayer video encoding/decoding process.

Embodiments of the present invention have been described for illustrative purposes, and those skilled in the art will appreciate that various modifications, additions and substitutions are possible without departing from the spirit and scope of the invention as disclosed in the accompanying claims.

What is claimed is:

1. A multilayer video encoding method comprising:
(a) encoding a first residual image obtained by subtracting a predicted frame from an original frame;
(b) decoding the encoded first residual image and generating a first restored frame by adding the decoded residual image to the predicted frame;
(c) deblocking the first restored frame; and
(d) encoding a second residual image obtained by subtracting the predicted frame from the first deblocked restored frame.

2. The method as claimed in claim 1, further comprising:
(e) generating a second restored frame by decoding the encoded second residual image and adding the decoded second residual image to the predicted frame; and
(f) providing the second restored frame as a reference frame for another frame.

3. The method as claimed in claim 2, wherein the predicted frame is the second restored frame obtained from a lower layer.

4. The method as claimed in claim 1, wherein (c) deblocks the first restored frame using a weak deblocking filter.

5. The method as claimed in claim 1, wherein (c) uses the same encoding method used in the step (a).

6. The method as claimed in claim 1, wherein (a) includes (al) performing quantization using a quantization parameter smaller in proportion to the level of a layer.

7. The method as claimed in claim 1, wherein (d) includes (d1) performing quantization using a quantization parameter smaller in proportion to the level of a layer.

8. A multilayer video decoding method comprising:
(a) extracting data corresponding to a residual image from a bit stream;
(b) restoring the residual image by decoding the data; and
(c) restoring a video frame by adding the residual image to a restored predicted frame,
wherein the bit stream is a bit stream of an encoded second residual image obtained by:
(d) encoding a first residual image obtained by subtracting the predicted frame from an original frame;
(e) decoding the encoded first residual image and generating a first restored frame by adding the decoded first residual image to the predicted frame, (f) deblocking the first restored frame; and
(g) encoding a second residual image obtained by subtracting the predicted frame from the first deblocked restored frame.

9. The method as claimed in claim 8, wherein (f) deblocks the first restored frame using a weak deblocking filter.

10. The method as claimed in claim 8, wherein (f) uses the same encoding method used in the step (d).

11. The method as claimed in claim 8, wherein (d) includes (d1) performing quantization using a quantization parameter smaller in proportion to the level of a layer.

12. The method as claimed in claim 8, wherein (g) includes (g1) performing quantization using a quantization parameter smaller in proportion to the level of a layer.

13. A multilayer video encoder comprising:
a temporal transform unit operative to remove a temporal redundancy of a first residual image obtained by subtracting a predicted frame from an original frame;
a spatial transform unit operative to remove a spatial redundancy of the first residual image from which the temporal redundancy has been removed;
a quantization unit operative to quantize transform coefficients provided by the spatial transform unit;
an entropy encoding unit operative to encode the quantized transform coefficients;
a dequantization unit operative to dequantize the quantized transform coefficients;
an inverse spatial transform unit operative to generate a first restored residual image by performing an inverse spatial transform on the dequantized transform coefficients; and
a deblocking unit operative to deblock the first restored frame by adding the first restored residual image to the predicted frame,
wherein the spatial transform unit removes the spatial redundancy of a second residual image obtained by subtracting the predicted frame from the first deblocked restored frame.

14. The multilayer video encoder as claimed in claim 13, wherein the inverse spatial transform unit generates a second restored residual image by performing the inverse spatial transform on the dequantized transform coefficients, and generates a second restored frame that is used as a reference frame for another frame by adding the second restored residual image to the predicted frame.

15. The multilayer video encoder as claimed in claim 14, wherein the predicted frame is the second restored frame obtained from a lower layer.

16. The multilayer video encoder as claimed in claim 13, wherein the deblocking unit deblocks the first restored frame using a weak deblocking filter.

17. The multilayer video encoder as claimed as claim 13, wherein the quantization unit performs the quantization using a quantization parameter smaller in proportion to the level of a layer.

18. A multilayer video decoder comprising:
an entropy decoding unit operative to extract data corresponding to a residual image from a bit stream;
a dequantization unit operative to dequantize the extracted data;
an inverse spatial transform unit operative to restore the residual image by performing an inverse spatial transform on the dequantized data; and
an adder operative to restore a video frame by adding the restored residual image to a pre-restored predicted frame,
wherein the bit stream is a bit stream of an encoded second residual image obtained by:
(a) encoding a first residual image obtained by subtracting the predicted frame from an original frame;
(b) decoding the encoded first residual image and generating a first restored frame by adding the decoded first residual image to the predicted frame;
(c) deblocking the first restored frame; and
(d) encoding a second residual image obtained by subtracting the predicted frame from the first deblocked restored frame.

19. The multilayer video decoder as claimed in claim 18, wherein the deblocking of the first restored frame is performed using a weak deblocking filter.

20. The multilayer video decoder as claimed in claim 18, wherein (d) includes (d1) performing quantization using a quantization parameter smaller in proportion to the level of a layer.

21. A recording medium for recording a computer-readable program that executes the method according to claim 1.

22. A recording medium for recording a computer-readable program that executes the method according to claim 8.
